(19) United States
(12) Patent Application Publication
(10) Pub. No.: US 2023/0001922 A1
(43) Pub. Date: Jan. 5, 2023

(54) SYSTEM PROVIDING BLIND SPOT SAFETY WARNING TO DRIVER, METHOD, AND VEHICLE WITH SYSTEM

(71) Applicant: TRIPLE WIN TECHNOLOGY(SHENZHEN) CO.LTD., Shenzhen (CN)

(72) Inventor: KUO-HUNG LIN, New Taipei (TW)

(21) Appl. No.: 17/551,501

(22) Filed: Dec. 15, 2021

(30) Foreign Application Priority Data
Jul. 1, 2021 (CN) 202110746176.1

(51) Int. Cl. B60W 30/095; B60W 30/18; B60W 30/12; G06V 20/58; B60W 50/16; B60R 1/00

(52) U.S. Cl. CPC B60W 30/0956; B60W 30/18163; B60W 30/12; G06V 20/58; B60W 50/16; B60R 1/00; B60W 2420/42; B60R 2300/8093; B60W 2050/146

(57) ABSTRACT

A system and method for reducing the risk of road accidents on account of blind spot errors and a vehicle using the system and method includes a visual sensing unit, the visual sensing unit comprising a first camera and a second camera, wherein the first camera looks left and obtains a first image information, the second camera looks to the right and obtains a second image information; a pre-processing unit, the pre-processing unit being coupled with the visual sensing unit, wherein the pre-processing unit processes the first image information and the second image information to generate a single image. An image processing unit generates an obstacle recognition information according to the processed image.

### CROSS-REFERENCE TO RELATED APPLICATIONS

This application claims priority to Chinese Patent Application No. 202110746176.1 filed on Jul. 1, 2021 in China National Intellectual Property Administration, the contents of which are incorporated by reference herein.

### FIELD

The subject matter herein generally relates to road safety technology field.

### BACKGROUND

As economy and technology developed, vehicle ownership increases year by year. Nevertheless, there is a great potential hazard to safety in blind spots of vehicles. Currently, vehicles can be equipped with a Lane Departure Warning (LDW) system and a Blind Spot Monitoring (BSM) system to increase visual areas of drivers, which can reduce accidents and burden on drivers. However, blind spots around vehicles may still exist despite of utilization of the LDW and the BSM systems.

Therefore, there is room for improvement within the art.

### BRIEF DESCRIPTION OF THE DRAWINGS

Implementations of the present disclosure will now be described, by way of embodiments, with reference to the attached figures.

FIG. 1 is a diagram of blind spots of a vehicle with an LDW system and a BSM system in prior art.

FIG. 2 is a diagram of an embodiment of a vehicle warning system according to the present disclosure.

FIG. 3 is a flowchart of a method providing vehicle warning in one embodiment according to the present disclosure.

FIG. 4 is a diagram of an embodiment of a vehicle according to the present disclosure according to the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “including” means “including, but not necessarily limited to”; it specifically indicates open-ended inclusion or membership in a so-described combination, group, series, and the like.

With a development of economy and technology, vehicle ownership increases year by year. Nevertheless, a blind spot of vehicles is a potential hazard. Currently, vehicles can be equipped with a Lane Departure Warning (LDW) system and a Blind Spot Monitoring (BSM) system to increase a visual area of drivers, which reduces accident injuries and driving burden. However, the LDW system and the BSM system still have a blind spot.

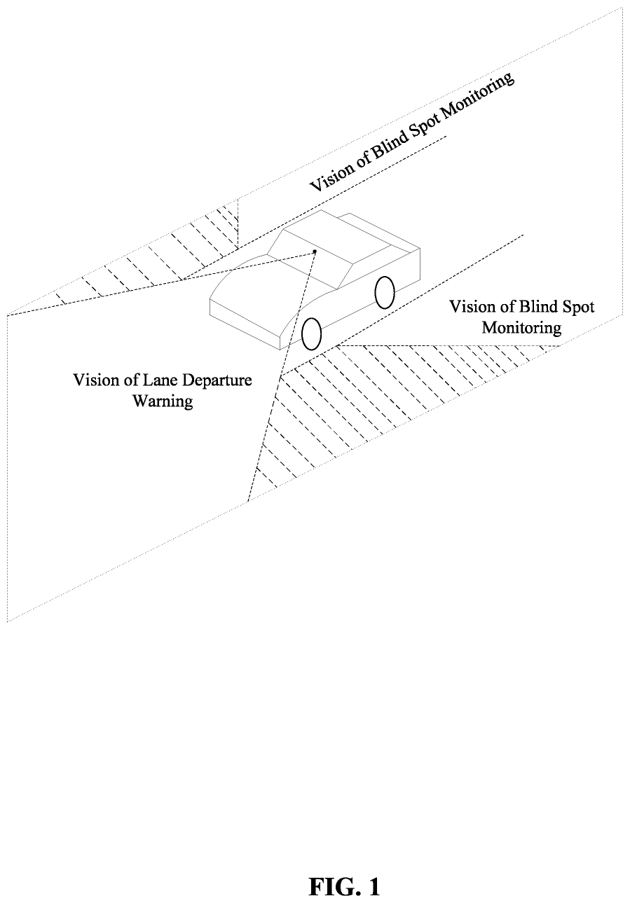

For example, FIG. 1 illustrates a diagram of blind spots of a vehicle with an LDW system and a BSM system in prior art. Dashed lines show ranges of a visual area of the LDW system and the BSM system, and areas of dashed lines across the direction of travel are in a blind spot of the vehicle. As shown in FIG. 1, vehicles with both the LDW system and the BSM system still have a blind spot. Drivers may be unable to make accurate judgement due to existence of vehicle or other obstacles in the blind spot, which leads to higher safety risks.

Therefore, the present disclosure provides a system, a method and a vehicle for vehicle warning, which detects obstacles in the blind spot of the vehicle and issues alerts.

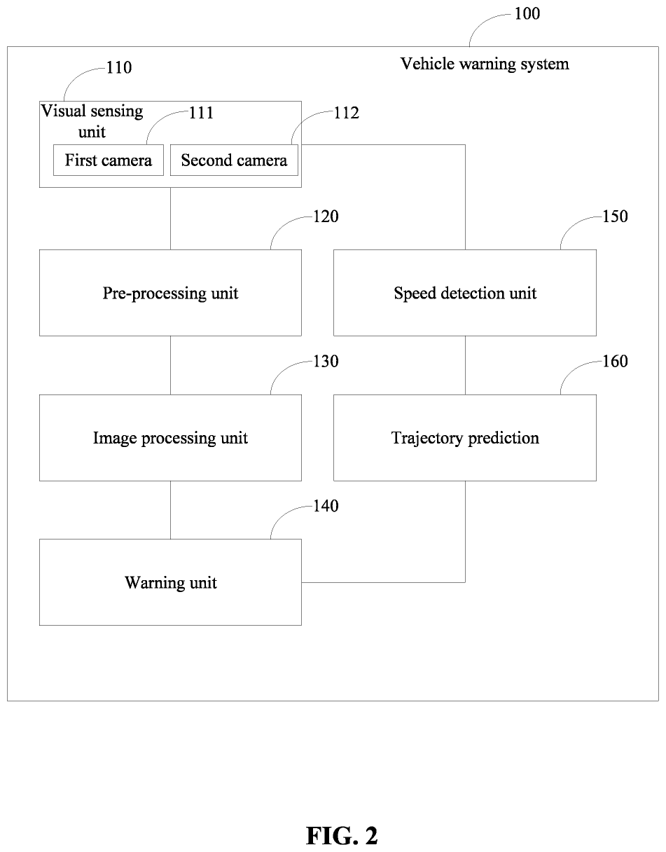

FIG. 2 illustrates a diagram of an embodiment of the vehicle warning system 100. The vehicle warning system 100 at least includes a visual sensing unit 110, a pre-processing unit 120, an image processing unit 130, a warning unit 140, a speed detection unit 150, and a trajectory prediction 160.

In this embodiment, the visual sensing unit 110 include a first camera 111 and a second camera 112. The first camera 111 is set on a left-hand (according to the direction of driving) A-pillar of the vehicle. The first camera 111 is configured for obtaining images at the left-hand side of the vehicle. The second camera 112 sets on a righthand A-pillar of the vehicle. The second camera 112 is configured for obtaining images on the righthand side of the vehicle.

In this embodiment, the pre-processing unit 120 couples (e.g. electrically connects) the first camera 111 and the second camera 112. The pre-processing unit 120 is configured for preprocessing the image information behind the left A-pillar and from behind the right A-pillar into an image that can be recognized by a machine vision algorithm, which allows the image processing unit 130 to recognize and process the pre-processed image information.

In this embodiment, the image processing unit 130 is coupled to the pre-processing unit 120. The image processing unit 130 is configured for generating an obstacle recognition information according to the machine vision algorithm. The obstacle recognition information includes, but is not limited to, an obstacle type, and, if the obstacle is in motion, obstacle trajectory, and an obstacle relative speed. For example, in one embodiment, the image processing unit 130 generates the obstacle type according to the machine vision algorithm. The type of obstacle can include a vehicle, pedestrian, bicycle, motorbike, electric motorbike, and others.

In this embodiment, after the obstacle type is identified, the image processing unit 130 is further configured to locate the obstacle according to the obstacle type and a wheel detection algorithm. For example, if the detected obstacle type is a wheeled type of obstacle (e.g., vehicle, bicycle, motorcycle, hand cart), the obstacle can be located according to the wheel detection algorithm.

In one embodiment, if the obstacle type is vehicle, the image processing unit 130 is further configured for identifying whether the obstacle includes windows according to a window detection algorithm and locates the vehicle according to a location of the windows.

In this embodiment, when the image processing unit 130 detects the obstacle type, the image processing unit 130 is further configured for detecting whether the type of obstacle is a vehicle according to a detection of wheels. For example, the image processing unit 130 is further configured for detecting the received image information from the visual sensing unit 110 using a circular or elliptical detection algorithm to determine whether the detected obstacle is a vehicle. Since a wheel has an elliptical or circular appearance as the vehicle traverses the scene, then the obstacle is determined as being a wheeled vehicle through the circular or elliptical detection algorithm.

In other embodiments, a wheel of a wheeled obstacle or vehicle is not limited to being detected by using the circular or elliptical detection algorithm, and may be detected by a Hough transform algorithm or other algorithms or methods. For example, the vehicle may be detected by one or more of detection of a tire, of a wheel rim detection, of spokes, and/or wheel hub detection.

As described above, when the type of the obstacle is determined to be a vehicle, the image processing unit 130 is further configured to determine whether the obstacle includes a window according to a window detection algorithm and locate the vehicle according to the position of the window.

For example, the window detection can be performed using a color difference or a straight-line effect. In other embodiments, the image processing unit 130 is not limited to performing window detection by using the color difference or the straight special effect and may also perform window detection by using other detection methods, not being limited in this disclosure.

The speed detection unit 150 is coupled to the visual sensing unit 110. The speed detection unit 150 is configured for receiving image from the visual sensing unit 110. The speed detection unit 150 performs speed detection according to the image from the visual sensing unit 110 and a high-speed vision algorithm, to obtain a relative speed between the obstacle and the vehicle. In other embodiments, the speed detection unit 150 can also be connected to a radar, an infrared distance meter, etc. Then, the speed detection unit 150 can calculate the relative speed according to the relative displacement and time between the vehicle and the obstacle.

In this embodiment, the trajectory prediction 160 is coupled to the speed detection unit 150. The trajectory prediction 160 is configured for predicting the trajectory of the obstacle according to the relative speed detected by the speed detection unit 150.

In one embodiment, the trajectory prediction unit 160 can be further coupled to the first camera 111 and the second camera 112. The trajectory prediction 160 is configured for performing prediction of obstacle trajectory according to the image information collected by the first camera 111 and the second camera 112 and the relative speed from the speed detection unit 150.

In other embodiments, the trajectory prediction unit 160 can be connected to other information collection devices of the vehicle to perform the obstacle trajectory predictions. For example, the trajectory prediction unit 160 acquires a distance between an obstacle and the driven vehicle from a radar mounted on the driven vehicle, and calculate a trajectory between the obstacle and the driven vehicle from two distances to the obstacle as measured by the vehicle-mounted radar and positions thereof.

In one embodiment, the image processing unit 130 is also coupled with the trajectory prediction unit 160. The image processing unit 130 is configured for receiving the predicted trajectory of the obstacle transmitted by the trajectory prediction unit 160 and determining whether a risk of traffic accident exists according to the trajectory and a relative speed of the obstacle. If the image processing unit 130 detects a risk of traffic accident according to the trajectory and the relative speed of the obstacle, the image processing unit 130 further controls the warning unit 140 to generate an alert.

In some embodiment, the alert notification includes sound and light warning, displaying alert notification on a center console, steering wheel vibration, and the like, and the disclosure is not limited herein.

In one embodiment, the image processing unit 130 is further configured for classifying the level of risk associated with the alert notification. For example, when a risk level is low, the image processing unit 130 controls the warning unit 140 to perform warning by a light. When the risk level is medium, the image processing unit 130 controls the warning unit 140 to perform warning audibly. When the risk level is high, the image processing unit 130 controls the warning unit 140 to perform warning with sound and with steering wheel vibration, which will guarantee the driver receiving the alert notification, for him or her to take action.

In one embodiment, the image processing unit 130 is further configured to control the warning unit 140 to perform the alert notification, after receiving the obstacle trajectory prediction information transmitted by the trajectory prediction unit 160. The vehicle may be about to turn or cross to another lane when the obstacle is determined to be present in the blind spot. For example, when the image processing unit 130 obtains from the trajectory prediction unit 160 that there is a vehicle in the blind spot on the left-hand side of the vehicle and the vehicle wants to turn left, the image processing unit 130 may control the warning unit 140 to issue a warning, such as the sound warning or the steering wheel vibration.

In one embodiment, the warning unit 140 can include a loudspeaker, a screen, or warning light etc. The warning unit 140 is couple to the image processing unit 130. The warning unit 140 is configured for displaying the alert notification after receiving the obstacle recognition information from the image processing unit 130. For example, in one embodiment, the warning unit 140 can be mounted on a left-hand or righthand rearview mirror of the vehicle. Therefore, after detecting an obstacle in the left blind spot of the vehicle, the image processing unit 130 can control the warning unit 140 to display alert notification in the left-hand rearview mirror.

In one embodiment, the warning unit 140 can set in the center console or inside the A-pillar of the vehicle. The warning unit 140 shows alert notification in the center console or inside the A-pillar after the image processing unit 130 detects obstacle. For example, if the image processing unit 130 detects obstacle in the left blind spot, the warning unit 140 shows alert notification in the left A-pillar of the vehicle.

In one embodiment, the vehicle warning system 100 can be combined with the LDW system and the BSM system. As shown in FIG. 1, the LDW system is configured to detect obstacle in the front of the vehicle, the vehicle warning system 100 is configured to detect obstacle in the side of the vehicle, and the BSM system is configured to detect obstacle behind the vehicle. A combination of the three systems achieves omni-directional monitoring of the vehicle, acts to eliminate the dangers of blind spot of vision, and improves the safety factor of the vehicle when running.

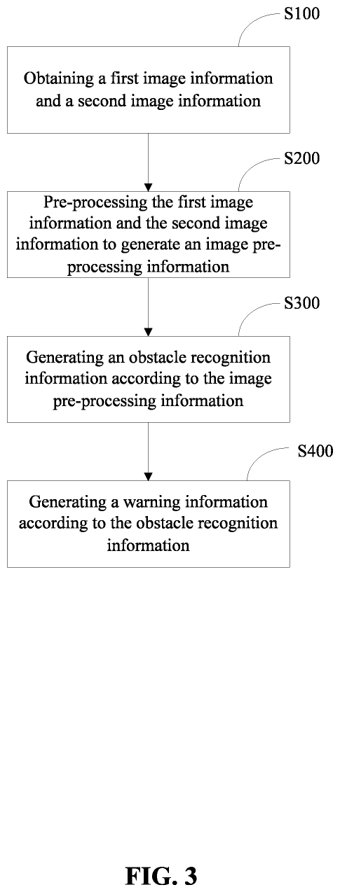

FIG. 3 illustrates a flowchart of an embodiment of the vehicle warning method. The embodiment is provided by way of example, as there are a variety of ways to carry out the method. The method described below can be carried out using the configurations illustrated in FIG. 2, for example, and various elements of these figures are referenced in explaining the embodiment. The method including: obtaining a first image information and a second image information from the first camera 111 and the second camera 112 and generating an alert information according to the first image information and the second image information. Each block shown in FIG. 3 represents one or more processes, methods, or subroutines carried out in the embodiment. Furthermore, the illustrated order of blocks is by example only, and the order of the blocks can be changed. Additional blocks can be added or fewer blocks can be utilized, without departing from this disclosure. This method can begin at block S100.

At block S100, a first image information and a second image information are obtained.

In block S100, the vehicle warning system 100 can obtain the first image information from the first camera 111 and obtains the second image information from the second camera 112.

At block S200, the first image information and the second image information are pre-processed to generate an image pre-process information.

At block S200, for example, the information formats of the first image information and the second image information may be converted into image pre-processing information that can be recognized by a machine vision algorithm through the pre-processing unit 120, so that the image processing unit 130 can recognize and process the image pre-processing information.

At block S300, the image processing unit 130 performs obstacle classification according to the image preprocessing information and the machine vision algorithm.

At block S400, the image processing unit 130 determines whether it is necessary to generate the alert notification through the warning unit 140 according to the recognition result of the obstacle. If it is necessary to generate the alert notification, the image processing unit 130 controls the warning unit 140 to generate the alert notification.

In an embodiment of the present disclosure, the method may further include performing a speed detection according to a high-speed vision algorithm and the first image information or the second image information to obtain a relative speed between the obstacle and the car. Specifically, the relative speed between the obstacle and the vehicle can be obtained by coupling the speed detection unit 150 to the visual sensing unit 110, and performing speed detection according to the first image information or the second image information through the speed detection unit 150.

In an embodiment of the present disclosure, the method may further include predicting a trajectory of the obstacle according to the relative speed. Specifically, the prediction of the trajectory between the obstacle and the vehicle may be obtained by the trajectory prediction unit 160.

In an embodiment of the present disclosure, the method may further include generating alert notification according to a trajectory prediction between the obstacle and the car. Specifically, the image processing unit 130 is coupled to the trajectory prediction unit 160 and the warning unit 140. The image processing unit 130 acquires trajectory prediction information from the trajectory prediction unit 160, determines whether there exists a collision risk, and controls the warning unit 140 to generate alert notification if there is a collision risk. It is understood that the image processing unit 130 may be a chip. For example, the image processing unit 130 may be a Field Programmable Gate Array (FPGA), an Application Specific Integrated Circuit (ASIC), a system on chip (SoC), a Central Processor Unit (CPU), a Network Processor (NP), a Digital Signal Processor (DSP), a Microcontroller (MCU), a Programmable Logic Device (PLD) or other integrated chips.

It will be appreciated that the steps of the above method may be performed by instructions in the form of hardware integrated logic circuits or software module in the image processing unit 130. The steps of the method disclosed in connection with the embodiments of the present disclosure may be directly implemented by a hardware processor, or implemented by a combination of hardware and software modules in the image processing unit 130. The software modules may be stored in ram, flash, rom, prom, or eprom, registers, etc. as is well known in the prior art.

In one embodiment, the image processing unit 130 in the embodiment of the present disclosure may be an integrated circuit chip having signal processing capability. In implementation, the steps of the above method embodiments may be performed by integrated logic circuits of hardware in a processor or by instructions in the form of software. The processor described above may be a general purpose processor, a Digital Signal Processor (DSP), an Application Specific Integrated Circuit (ASIC), a Field Programmable Gate Array (FPGA) or other programmable logic device, discrete gate or transistor logic, discrete hardware components. The various methods, steps, and logic blocks disclosed in the embodiments of the present disclosure may be implemented or performed. A general purpose processor may be a microprocessor or the processor may be any conventional processor or the like. The steps of the method disclosed in connection with the embodiments of the present disclosure may be directly implemented by a hardware decoding processor, or implemented by a combination of hardware and software modules in the decoding processor. The software modules may be stored in ram, flash, rom, prom, or eprom, registers, etc. as is well known in the art. The storage medium is located in a memory, and a processor reads information in the memory and combines hardware thereof to complete the steps of the method.

In one embodiment, the first camera 111 and the second camera 112 in the visual sensing unit 110 are used for collecting the vision image of the blind spot of the vehicle. The working principle of the first camera 111 and the second camera 112 is to collect images through a lens, and then the collected images are processed by an internal photosensitive assembly and a control assembly and further converted into digital signals which can be recognized by other systems; other systems obtain digital signals through the transmission ports of the first camera 111 and the second camera 112, and then perform image restoration to obtain an image consistent with an actual scene. In practical application, the visual field range of the image data collected by the camera and the installation amount and the installation position of the camera can be further designed into a feasible scheme according to actual needs. The embodiment of the application does not specifically limit the visual field range, the installation amount and the installation position of the cameras. It is understood that the types of the first camera 111 and the second camera 112 can be selected according to different requirements of users, as long as basic functions of video shooting, broadcasting, still image capturing, and the like can be realized. For example, the camera may be one or more types of commonly used vehicle-mounted cameras, such as a binocular camera and a monocular camera.

In one embodiment, the first camera 111 and the second camera 112 may be one or two types of digital cameras and analog cameras if selected according to the signal category, and the difference is that the image processing process for the lens collection is different. The digital camera converts the collected analog signals into digital signals for storage, and the analog camera converts the analog signals into a digital mode by using a specific video capture card, compresses the analog signals and stores the compressed analog signals. If the cameras are classified according to the image sensor category in the cameras, the cameras can also be one or both of a Complementary Metal Oxide Semiconductor (CMOS) type camera and a charge-coupled device (CCD) type camera.

In one embodiment, the first camera 111 and the second camera 112 may also be one or more types of Serial ports, parallel ports, Universal Serial Bus (USB), and firewire interface (IEEE1394) if divided by interface type. The embodiment of the present disclosure also does not specifically limit the type of the camera.

An embodiment of the present disclosure further provides a computer readable storage medium having stored there on a computer program which, when executed by a processor, implements the vehicle warning method as described above.

The readable medium may be a readable signal medium or a readable storage medium. A readable storage medium may be, for example, but not limited to, an electronic, magnetic, optical, electromagnetic, infrared, or semiconductor system, apparatus, or device, or any combination of the foregoing. More specific examples (a non-exhaustive list) of the readable storage medium include: an electrical connection having one or more wires, a portable diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

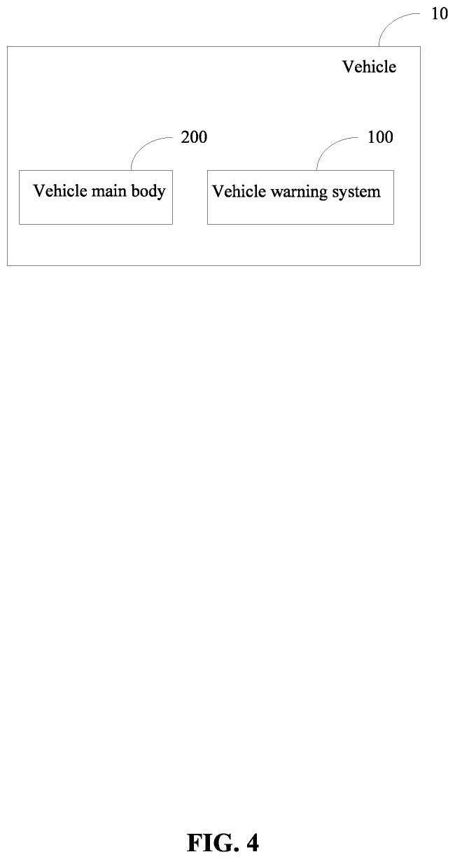

FIG. 4 illustrates a diagram of an embodiment of a vehicle 10. The vehicle 10 includes a vehicle main body 200 and the vehicle warning system 100.

An embodiment of the present disclosure provides the vehicle 10 including the vehicle warning system 100 as described above, or the computer readable storage medium as described above.

In an embodiment of the present disclosure, the vehicle 10 includes any vehicles such as cars trucks and buses, and vehicles such as two and three wheelers are also included.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A vehicle warning system, applicable in vehicles, the vehicle warning system comprising:
a visual sensing unit comprising a first camera and a second camera, wherein the first camera is located on a left A-pillar of a vehicle and is configured for obtaining a first image information, the second camera is located on a right A-pillar of the vehicle and is configured for obtaining a second image information;
a pre-processing unit coupled with the visual sensing unit, wherein the pre-processing unit is configured for pre-processing the first image information and the second image information to generate an image pre-processing information; and
an image processing unit configured for generating an obstacle recognition information according to the image pre-processing information.

2. The vehicle warning system of claim 1, further comprising:
a warning unit coupled with the image processing unit and configured for generating an alert information according to the obstacle recognition information.

3. The vehicle warning system of claim 1, wherein the image processing unit generates the obstacle recognition information according to a machine vision algorithm.

4. The vehicle warning system of claim 1, wherein the obstacle recognition information comprising an obstacle, an obstacle type, an obstacle trajectory, and an obstacle relative speed.

5. The vehicle warning system of claim 4, wherein an obstacle type comprising at least one of a vehicle, pedestrian, bicycle, motorbike, and battery motorbike.

6. The vehicle warning system of claim 4, further comprising:
a speed detection unit coupled with the visual sensing unit and configured for calculating the obstacle relative speed between the obstacle and the vehicle according to the first image information and the second image information.

7. The vehicle warning system of claim 6, further comprising:
a trajectory prediction unit coupled with each of the speed detection unit and the image processing unit, and configured for performing an obstacle trajectory prediction according to the obstacle trajectory, the obstacle relative speed, the first image information, and the second image information.

8. The vehicle warning system of claim 7, wherein the image processing unit is further configured for generating the alert information according to the obstacle trajectory and the relative speed between the obstacle and the vehicle.

9. A vehicle warning method comprising:
obtaining a first image information and a second image information;
pre-processing the first image information and the second image information to generate an image pre-processing information; and
generating an obstacle recognition information according to the image pre-processing information; and
generating an alert information according to the obstacle recognition information.

10. The vehicle warning method of claim 9, wherein the obstacle recognition information comprising an obstacle, an obstacle type, an obstacle trajectory, and an obstacle relative speed.

11. The vehicle warning method of claim 10, wherein the method further comprising:
calculating the obstacle relative speed between the obstacle and the vehicle according to the first image information and the second image information.

12. The vehicle warning method of claim 12, wherein the method further comprising:
predicting an obstacle trajectory of the obstacle according to the relative speed.

13. The vehicle warning method of claim 12, wherein the method further comprising:
generating the alert information according to the obstacle trajectory and the relative speed between the obstacle and the vehicle.

14. A vehicle comprising:
a vehicle main body;
a visual sensing unit comprising a first camera and a second camera, wherein the first camera is located on a left A-pillar of a vehicle and is configured for obtaining a first image information, the second camera is located on a right A-pillar of the vehicle and is configured for obtaining a second image information; and
a pre-processing unit coupled with the visual sensing unit, wherein the pre-processing unit is configured for pre-processing the first image information and the second image information to generate an image pre-processing information; and
an image processing unit configured for generating an obstacle recognition information according to the image pre-processing information.

15. The vehicle of claim 14, wherein the vehicle further comprising:
a warning unit coupled with the image processing unit, is configured for generating an alert information according to the obstacle recognition information.

16. The vehicle of claim 14, wherein the obstacle recognition information comprising an obstacle, an obstacle type, an obstacle trajectory, and an obstacle relative speed.

17. The vehicle of claim 16, wherein the obstacle type comprising a vehicle, pedestrian, bicycle, motorbike, battery motorbike, and other type of obstacle.

18. The vehicle of claim 17, wherein the vehicle further comprising:
a speed detection unit coupled with the visual sensing unit, the speed detection unit is configured for calculating the obstacle relative speed between the obstacle and the vehicle according to the first image information and the second image information.

19. The vehicle of claim 18, wherein the vehicle further comprising:
a trajectory prediction unit coupled with the speed detection unit and the image processing unit, the trajectory prediction unit is configured for performing an obstacle trajectory prediction according to the obstacle trajectory, obstacle relative speed, the first image information, and the second image information.

20. The vehicle of claim 19, wherein the image processing unit is further configured for generating the alert information according to the obstacle trajectory and the relative speed between the obstacle and the vehicle.
